(19) United States
(12) Patent Application Publication
(10) Pub. No.: US 2005/0120134 A1
(43) Pub. Date: Jun. 2, 2005

(54) Methods and structures for a caching to router in iSCSI storage systems

(76) Inventor: Walter Hubis, Louisville, CO (US)

Correspondence Address: LSI LOGIC CORPORATION, 1621 BARBER LANE, MS: D-106, MILPITAS, CA, 95035, US

(21) Appl. No.: 10/714,031

(22) Filed: Nov. 14, 2003

(51) Int. Cl. G06F 15/173; G06F 12/00; G06F 13/00

(52) U.S. Cl. 709/238; 711/118

(57) ABSTRACT

Methods and structure for integrating storage caching and network routing features within a single network appliance. One feature hereof provides routing features in a TCP/IP network in combination with block oriented storage caching features. Another feature hereof provides that the caching router may coalesce smaller requests into fewer, larger requests. Such features are particularly useful in iSCSI storage network applications in which low layer block oriented SCSI commands and responses are exchanged over TCP/IP network communication media.

### BACKGROUND OF THE INVENTION

1. Field of the Invention

The invention relates generally to storage systems and more specifically relates to a network router with caching capabilities for local processing of iSCSI block level requests to improve storage subsystem performance in storage networks.

2. Discussion of Related Art

SCSI is a protocol that has evolved over many years into a widely accepted and utilized standard for high performance interfaces between computing systems and peripherals storage devices (as well as other peripheral I/O devices). In its original form, SCSI standards include electrical interfacing standards for a parallel bus a structure as well as a command and response protocol for exchanging information between host systems (e.g., SCSI initiators) and attached peripheral devices (e.g. SCSI targets). As SCSI has evolved, the command and response protocol structures have been applied to numerous other communication media. For example, SCSI command and response protocols are now applied via numerous high speed serial communication media such as Fibre Channel and Ethernet.

In one particular, relatively recent, development of SCSI interfacing, SCSI command and response protocols are applied to TCP/IP communication links. TCP/IP communication protocols and standards are widely accepted for network computing applications within a computing enterprise (e.g., local area networking or LANs) and for geographically dispersed computing enterprises using wide area networking (e.g., WANs). As so applied to TCP/IP networks, use of the SCSI protocols is often referred to as iSCSI.

In general, protocols involved in access to storage may be either file oriented or block oriented. Storage systems are generally organized as blocks of storage. Each block is associated with a block address (i.e., a logical block address or an LBA). A file is a higher layer, logical construct that associates one or more related blocks with a file name or other identifier. File oriented access identifies a file by its name for access to all storage blocks of the file. Such higher layer file requests are translated at some point in processing into associated lower layer block requests to access the actual storage blocks associated with the file.

In storage networks, file oriented requests may be forwarded through the network communication medium until the request is eventually translated into lower layer block oriented requests at the computing/storage node that is directly coupled to the storage devices. Network file systems (NFS) is one example of such a file oriented network storage protocol. Other network storage architectures forward lower layer block oriented requests through the network communication medium and deliver the lower layer requests directly to the storage devices attached to the communication medium. In such a case, the translation from a file request to associated block requests takes place, generally, at the node or device that initiates the file oriented request. Fibre Channel connectivity is a common example of such a block oriented network storage architecture.

There are benefits associated with each network storage architecture. File oriented architectures are common in numerous existing storage network applications. NFS, for example, has been in worldwide use for decades. However, file oriented requests may require that the processing overhead associated with translating higher layer file requests into lower layer block requests be incurred at multiple nodes in the network. By contrast, block oriented incur such overhead at the node originating the request, just as though the node is accessing locally attached storage devices, and at no other nodes within the network. However, many current block oriented storage network applications utilize costly communication media (such as Fibre Channel) that require numerous custom communication devices.

Although TCP/IP protocols have been used for decades for exchange of data between systems, as applied to storage networks, only file oriented protocols but have been used therewith until recently. By comparison, iSCSI utilizes TCP/IP protocols to transfer lower layer block I/O requests through the network communication medium. By utilizing long established TCP/IP protocols, iSCSI may be applied to storage networks using presently existing, time-proven, less costly network communication media. iSCSI therefore presents users with a compromise that permits use of existing network communication infrastructure while benefiting from reduced storage related processing overhead.

Use of such well established TCP/IP networking protocols and related communication media also allows for application of similarly well known, time-proven networking devices (i.e., networked appliances) such as, hubs, switches, routers, etc. Such network appliances allow system or network administrators to effectively manage networked communication security and media bandwidth utilization aspects of a network communication infrastructure. Network traffic may be segregated by hubs and switches such that various subnets of a communication infrastructure may be isolated from network traffic of other subnets. Such architectures are useful to improve utilization of available bandwidth in a networked enterprise. Further, router network appliances are useful to permit one subnet or segment of the network enterprise to access other subnets or segments or even other networks outside the networked enterprise.

In the storage arts it is also well known to utilize caching techniques to improve performance in accessing storage devices. Caching techniques utilize a high speed buffer memory to store recently accessed information stored on the storage devices such that subsequent requests for the same data may be satisfied by the information in the cache buffer memory. Accessing the requested data from the cache memory rather than on the storage device is generally much faster. Caching therefore improves overall storage system performance by increasing the speed of access to previously stored data.

In such networked storage applications, including iSCSI configurations, it is an ongoing problem to improve performance in accessing storage devices. Applications, including in particular multimedia applications, continue to demand higher and higher performance levels from storage subsystems. It is therefore evident from the above discussion that an ongoing need exists for further improvement in network storage performance including, in particular, iSCSI network storage applications.

### SUMMARY OF THE INVENTION

The present invention solves the above and other problems, thereby advancing the state of the useful arts, by providing methods and structure for integrating network routing features and storage caching features within a single network appliance. In particular, features and aspects hereof provide a caching router applicable to, for example, iSCSI network storage applications. The caching router provides routing capabilities well known in TCP/IP communications and couples such routing capabilities with block oriented storage caching features to improve block oriented I/O request processing in storage network applications including iSCSI storage applications.

A first feature hereof therefore provides a storage network appliance comprising: a TCP/IP router for routing block level storage requests through a TCP/IP network communication medium; and a cache memory for caching storage data blocks accessed by the block level storage requests.

Another aspect hereof further provides a command and response processor coupled to the router for interpreting block level storage requests routed through the router and coupled to the cache memory for caching data identified in the interpreted block level storage requests.

Another aspect hereof further provides that the block level storage requests are iSCSI protocol commands and responses.

Another aspect hereof further provides that the command and response processor is a SCSI command and response processor.

Another aspect hereof further provides that the command and response processor is adapted to snoop the block level storage requests routed by the router.

Another aspect hereof further provides that the router is adapted to store and forward received requests.

Another aspect hereof further provides that the command and response processor is adapted to process received requests while the requests are temporarily stored for forwarding.

Another aspect hereof further provides that the command and response processor is adapted to retrieve information from the cache memory in response to identifying a request to access data previously stored in the cache memory.

Another aspect hereof further provides that the router is adapted to conditionally forward a received command in response to operation of the command and response processor retrieving the information from the cache memory.

Another aspect hereof further provides that the command and response processor is adapted to coalesce multiple block level storage write requests into a coalesced block level storage write request and further provides that the router is adapted to forward the coalesced block level write request to a destination device in place of the multiple block level storage write requests.

Another feature hereof provides a method operable in a network router comprising the steps of: receiving a block level storage request from a network communication medium; and processing the received block level storage request in association with a cache memory local to the router.

Another feature hereof provides an iSCSI router comprising: in inbound network interface for receiving iSCSI storage requests and for returning responses to received iSCSI storage requests; an outbound network interface for forwarding received iSCSI requests to a destination device and for receiving responses from the destination device; a cache memory; and a control element coupled to the inbound network interface, coupled to the outbound network interface, and coupled to the cache memory and adapted to process iSCSI requests received on the inbound network interface in association with the cache memory and adapted to selectively forward processed iSCSI requests to a destination device via the outbound network interface.

Another feature hereof provides an improved network router compatible with TCP/IP protocols and adapted for coupling to one or more host systems and one or more iSCSI compatible storage devices, the improvement comprising: a SCSI command and response processor within the router to process iSCSI commands and responses forwarded through the router; and a cache memory within the router coupled to the SCSI command processor for caching data related to iSCSI commands and responses processed by the SCSI command and response processor.

### BRIEF DESCRIPTION OF THE DRAWINGS

FIG. 1 is a block diagram of a system including features and aspects hereof for iSCSI routing with caching.

FIG. 2 is a block diagram of an exemplary embodiment of a router embodying features and aspects hereof.

FIG. 3 is a block diagram describing functional features and aspects hereof.

FIG. 4 is a flowchart describing operation of features and aspects hereof to provide routing and caching features and aspects hereof.

FIG. 5 is a flowchart describing operation of features and aspects hereof to provide routing and caching features and aspects hereof.

FIG. 6 is a flowchart describing operation of features and aspects hereof to provide routing and caching features and aspects hereof.

### DETAILED DESCRIPTION OF THE DRAWINGS

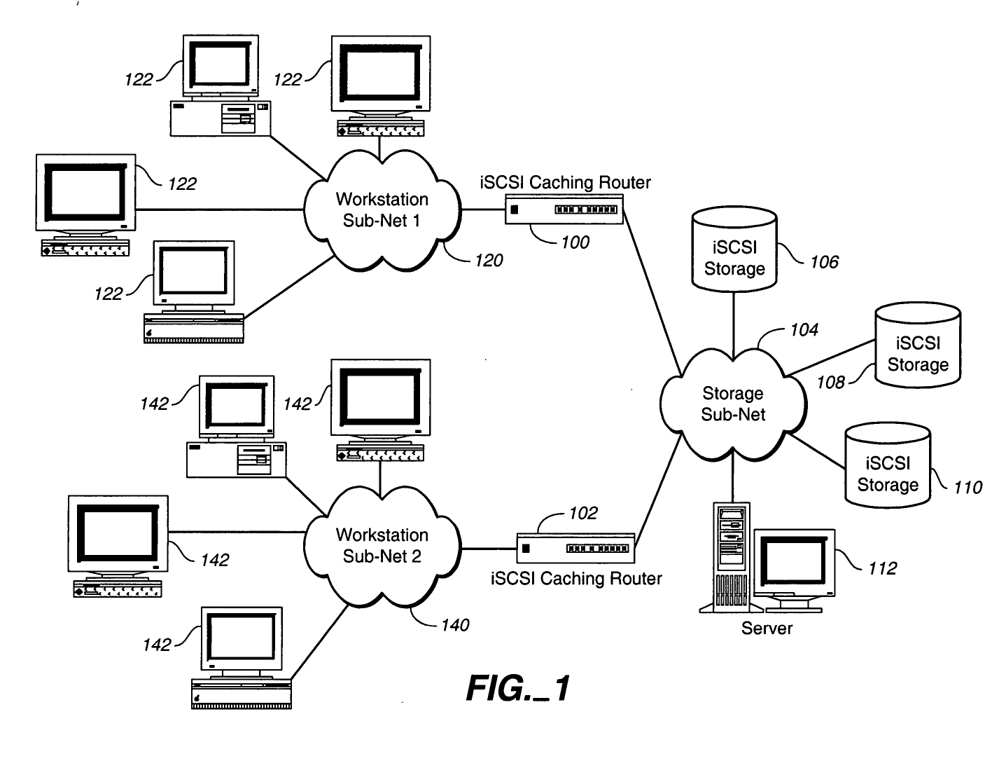

FIG. 1 is a block diagram depicting a computing enterprise utilizing iSCSI caching routers 100 and 102 operable in accordance with features and aspects hereof. A typical computing enterprise may include a plurality of user workstations 122 and 142. Workstations 122 may be utilized for a first purpose within the corporate enterprise while a second group of workstations 142 may be used by a different organization within the computing enterprise. For example, administration functions within an enterprise may utilize a first grouping (subnet) of workstations, engineering functions of the enterprise may use a second grouping, sales and marketing may be a further groupings, etc.

Each group of related workstations may be configured and adapted to operate within a single subnet. For example, as shown in FIG. 1, workstations 122 are configured as a first subnet 120 while workstations 142 are configured as a second, independent subnet 140. As is generally known in the art, subnet configurations allow system or network administrators to separate network traffic so as to reduce bandwidth utilization. In addition, subnet configurations of an enterprise network allows for segregation of network traffic for security and other purposes.

Workstations 122 associated with subnet 120 and workstations 142 associated with subnet 140 utilize storage capacity provided by storage subnet 104. Storage devices 106, 108, 110 and server 112 may be coupled to storage subnet 104. Server 112 may provide administrative features for storage devices 106 a through 110 of storage subnet 104. In addition, server 112 may provide file management server features on behalf of client processes running in subnet 120 or subnet 140.

As is known for iSCSI storage applications, workstations 122 of subnet 120 or workstations 142 of subnet 140 generate SCSI commands and transfer those commands through their respective subnets 120 and 140 to a storage subnet 104 for distribution to an appropriate storage device 106, 108 or 110. Standard routing features of caching router 100 and 102 enables the transfer of packets from one subnet to another subnet while maintaining the intended segregation of other network traffic exchanged completely with a subnet. SCSI commands are formatted as TCP/IP packets that may be switched and routed using standard network appliances for such communications.

iSCSI caching routers 100 and 102 provide such standard routing capabilities but couple these features with caching methods and structure in accordance with features and aspects hereof. In general, iSCSI caching router 100 receives inbound storage requests from workstations 122 coupled to subnet 120 and forwards the iSCSI command packets to storage subnet 104 for distribution to an appropriate a storage device 106, 108 or 110. As discussed further herein below, caching router 100 may also provide caching features to improve performance of the overall systems. In like manner, iSCSI caching router 102 provides similar routing and caching features for processing of requests generated by workstations 142 on subnet 140.

Response information generated by storage devices 106 through 110 on storage subnet 104 are returned through the appropriate iSCSI caching router 100 or 102 to the requesting workstation 122 or 142 on the appropriate subnet 120 or 140.

Caching features of iSCSI caching routers 100 or 102 provide enhanced performance for iSCSI storage applications. The caching features may be utilized to decrease network traffic overhead on the storage a subnet and thereby improve overall storage system performance. Rather than forwarding all requests through the router to the storage subnet, inbound requests may be processed completely within the caching router through access exclusively to the cache memory within the iSCSI caching router 100 or 102. Where a read request may be satisfied by data already stored in the iSCSI caching router's cache memory, system latency is reduced by returning the requested data more rapidly and network traffic directed to the storage a subnet may be eliminated. In like manner, a storage write request iSCSI packet received as an inbound request by the iSCSI caching router may be rapidly processed by a storing the write data in the iSCSI caching router's cache memory and then immediately signaling completion of the write request to the initiating host workstation. The write request may be referred to as “deferred” while it is temporarily stored in the caching router. Periodically, deferred write information in the iSCSI caching router's cache memory may be flushed to storage devices on the storage subnet for persistent storage. Features and aspects hereof permit the iSCSI caching router to coalesce to plurality of received write requests received from host systems into more efficient, larger, coalesced storage write requests. In particular, a plurality of a smaller write requests for storing information in the iSCSI storage devices may be coalesced into a single larger iSCSI write operation. Coalescing features and aspects hereof further enhance system performance by reducing network traffic on the storage subnet.

Those of ordinary skill in the art will readily recognize that the iSCSI caching router features and aspects hereof may be applied in numerous equivalent network configurations and topologies involving any number of workstations, subnets, and storage subnets with associated storage devices. FIG. 1 is therefore intended merely as exemplary of one possible application of the features and aspects hereof to provide iSCSI routing capabilities with cache memory features.

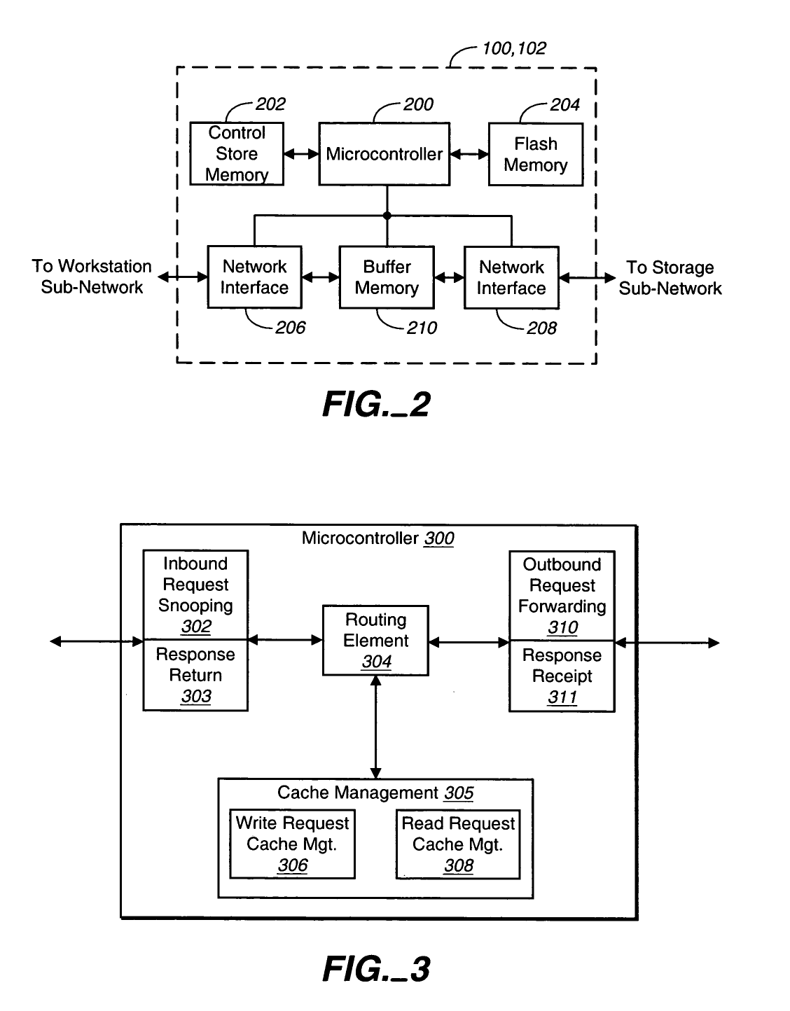

FIG. 2 is a block diagram providing additional details of an exemplary embodiment of the iSCSI caching router. Caching router 100 or 102 may include microcontroller 200 for controlling overall operation of the caching router including other components thereof. A control store memory 202 and/or flash memory 204 may provide program and data storage for operation of caching router 100 and 102. In particular, program instructions associated with microcontroller 200 may be stored and fetched from flash memory 204 while data used in operation of microcontroller 200 may be read and written in control store memory 202. Cache buffer memory 210 provides storage capacity for data caching features of the caching router. As noted above, caching router 100 or 102 may include both routing features for re-directing received network packets to appropriate destination devices on another subnet. iSCSI caching router 100 or 102 also include cache management features to further improve overall system performance in exchange of data between host systems and iSCSI storage devices coupled through the caching router. Data retrieved from responses to host read request may be stored in cache buffer memory 210. Data supplied with write requests may be written into cache buffer memory 210 to permit an early completion of the write request operation initiated by a host system. Subsequent read requests may then locate the requested data within cache buffer memory 210 to expedite processing of a received I/O read request from an attached host system.

Network interface 206 provides interface control logic for a network attachment to one or more host system subnets while network interface 208 provides similar control logic features for network attachment to one or more storage subnets. As a matter of design choice, the networks may utilize Ethernet or other network communication media and protocols.

Those of ordinary skill in the art will recognize a variety of similar configurations for components within iSCSI caching router 100 and 102. FIG. 2 is therefore intended merely as exemplary of one possible embodiment of features and aspects hereof.

FIG. 3 is a block of diagram describing functional elements operable within microcontroller 200 for managing routing and caching features of the iSCSI caching routers of FIG. 1. As noted above, micro controller 200 may fetch program instructions from a program memory device and may store and retrieve data and/or program instructions in an associated control memory. Elements operable within microcontroller 200 as shown in FIG. 3 therefore represent functional features operable within a suitably programmed microcontroller 200.

Inbound request snooping element 302 monitors receipt of inbound iSCSI request packets from, for example, one or more workstations (host systems) on one or more host subnets. As noted above, such networks may include, for example, Ethernet or other well known computer networking communication media. When inbound request snooping element 302 detects receipt of an inbound iSCSI request from a host system, further processing by routing element 304 assure proper routing of the request to an intended destination device as necessary. Element 303 forwards any required response for the inbound request back to the requesting host system. In like manner, outbound request forwarding element 310 is operable to forward iSCSI requests to iSCSI storage devices coupled to the caching router. As noted above, iSCSI storage devices may be coupled to the caching router using Ethernet or other well known computer networking communication media. Response receipt element 311 is operable to receive response data or status information returned from attached iSCSI storage devices in response to an iSCSI request forwarded from the caching router by operation of element 310. Such a received response may then be returned to a requesting host system as indicated above with respect to element 303.

Caching router features and aspects hereof also provide cache management features within that caching router to enhance overall system performance. In normal operation of any network router, I/O requests are initiated by a host system and transmitted to the router for forwarding out of the host subnet to an appropriate storage subnet that includes the intended destination storage device (i.e., the intended target device). Responses from the target device are then returned to the initiating host system in like manner through the router. In the caching router features hereof, routing element 304 of the microcontroller 200 receives the transmitted request from the inbound request snooping element 302 and may forward the request to the intended destination on the storage subnet via outbound request forwarding element 310. Responses generated by the target device (the destination of the forwarded request) are received in response receipt element 311 and passed to routing element 304 for further processing. Routing element 304 may return the response information (i.e., status and/or data) to the requesting host system (i.e., the initiator of the I/O request).

In accordance with features and aspects hereof, routing element 304 may interact with cache management element 305 as it processes requests. As write requests are processed, routing element 304 and write request cache management element 306 of cache management element 305 may interact to store the write data associated with the write request in the cache memory of the caching router. In like manner, when a read request is processed by routing element 304, read request cache management 308 of cache management element 305 interacts with routing element 304 to determine if the requested data is already resident in the cache memory of the caching controller. Further, when data is returned from an iSCSI storage device in response to a read request (via response receipt element 311), the returned data may be stored in cache buffer memory by operation of read request cache management 308 of cache management element 305 in conjunction with routing element 304.

In processing a received (inbound) read request, routing element 304 in cooperation with read request cache management element 308 will return the requested data from cache memory if available. Completing a read request from data resident in the caching router's cache memory improves performance by reducing system latencies associated with read request processing. If the requested data is not located in cache memory, the read request may be forwarded to an appropriate destination device in accordance with standard or routing features and aspects of the caching router. In addition, completion of the read request from cached data reduces the number of read requests forwarded to the iSCSI storage devices thereby reducing the network traffic applied to the storage subnet.

Similarly, processing of a write request by writing the supplied data into cache memory allows the write request to be completed prior to flushing the write data from the cache memory to the iSCSI storage devices thus reducing system latencies associated with write request processing. Appropriate non-volatile storage devices or other security techniques and structures (i.e., logging) may be employed to assure data integrity of such information stored in the router prior to flushing the data to the persistent storage of the iSCSI devices. In addition, routing element 304 in cooperation with cache management element 305 may also coalesce small write requests stored in the cache memory of the caching router into fewer, larger write requests so as to reduce the number of write requests forwarded to the storage subnet. Reducing the number of requests applied to the storage subnet improves system performance by reducing overhead network traffic applied to the storage subnet.

Those of ordinary skill in the art will recognize a variety of equivalent functional elements that may be operable within a microcontroller of a caching router to provide features and aspects hereof. The functional components depicted in FIG. 3 are therefore merely intended as exemplary of one possible functional decomposition of features and aspects hereof.

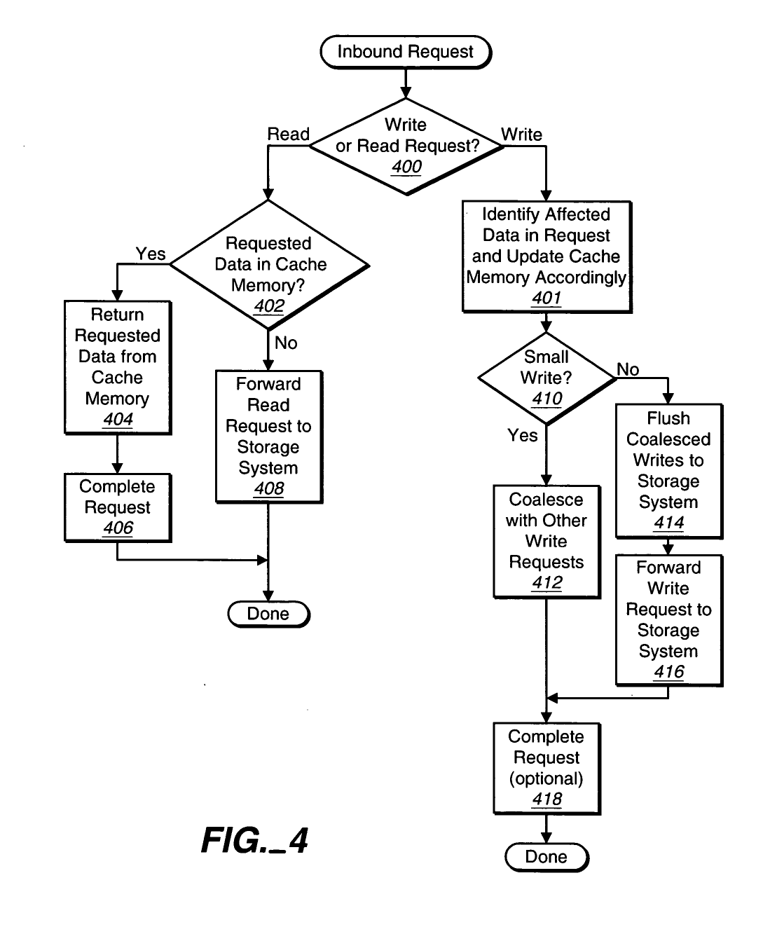

FIG. 4 is a flowchart describing inbound request processing within a caching router in accordance with features and aspects hereof. Element 400 is first operable in response to receipt of an inbound request from a host subnet coupled to the caching router. Element 400 determines whether the received request is for a read or write operation. If the received request is a read operation, element 402 is next operable to determine whether the requested data is already resident in cache buffer memory associated with the caching router. If so, element 404 is operable to return the requested data from cache memory to the requesting workstation. Element 406 then completes the read operation without requiring that the read request be forwarded to the intended destination iSCSI storage device. By completing read requests directly from cache memory of the caching routers, system performance may be enhanced by reducing system latencies in read requests and by reducing network traffic in the storage subnet. If element 402 determines that the requested data of the read request is not presently in cache memory, element 408 is operable to forward the read request to the identified iSCSI storage device in accordance with normal processing of a network router. Further processing responsive to receipt of the requested data from the read request may complete the read request and enter the returned data into the cache memory of the iSCSI caching router.

If element 400 determines that the received iSCSI request indicates a write operation, element 401 is next operable to update cache buffer memory with the data supplied in the write request. Data supplied with such a write request is thereby entered in the cache buffer memory to permit performance enhancements of the storage system as discussed herein. One aspect hereof enhances performance by coalescing a plurality of smaller write requests into a single, larger coalesced write operation. The coalesced write operating reduces network traffic overhead generated on the storage device subnet. To permit such coalescing, element 410 first determines whether the received write request qualifies as a “small” write request such that coalescing may be beneficial. Parameters for determining what size of requests may be coalesced into a larger request are matters of design choice for a particular application and are readily determined by those of ordinary skill in the art. If element 410 determines that the received write request is sufficiently small to allow coalescing with other write requests, element 412 is then operable to provide the coalescing features. In general, element 412 is operable to look for other small requests previously stored in cache buffer memory from previous write requests. When adjacent portions of data not yet written to the iSCSI storage devices are located in cache buffer memory, the adjacent portions to be written to the storage devices may be coalesced into a single larger request. Techniques and structures to tag data in cache as requiring flushing to persistent storage (i.e., “dirty data”) as well as techniques and structures to retain or generate write request information for such coalesced portions of data are readily apparent to those skilled in the art.

Element 418 is then operable to complete the processing of the received write request. Completion of the write request may entail returning status or other completion indicia to the requesting host system. Completing a request prior to forwarding data to the storage devices, i.e., upon successful storing of the data in cache memory, enhances system performance by more rapidly responding to the host write request allowing the host system to continue with other operations (i.e., reducing system latencies). As is generally known in the art, such an early completion of write requests requires that the data posted in cache of buffer memory be secured from loss or corruption due to power failure or other forms of system failure. Non-volatile memories and other well known techniques such as the request logging may be utilized to secure cached data from storage system failure.

If element 410 determines that the received write request is not sufficiently small to permit coalescing with other previously received requests, element 414 is then operable to flush any coalesced writes presently saved in cache buffer memory. The act of flushing cached (or logged) write operations forwards appropriate write requests to the iSCSI storage devices to provide persistent storage of the coalesced data. Element 416 is then operable to forward the newly received write request to the storage system subnet for application to the identified destination device or devices (i.e., the target(s)). Lastly, element 418 is operable as described above to complete the requested write operation and thereby permit the host workstation to continue with other processing.

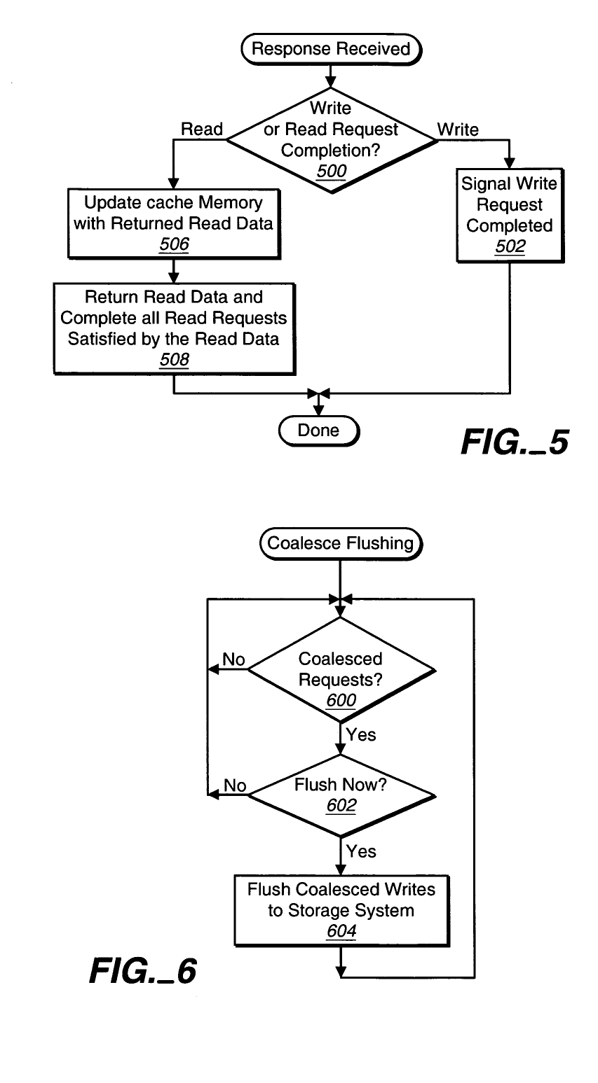

FIG. 5 is a flowchart describing a method operable to process a response received from an iSCSI device responsive to a request forwarded through the caching router features hereof. As noted above, a read request forwarded to an iSCSI storage device is completed in due course of processing by the storage device. A write request may be completed by the router in a status returned to the requesting host system when the write data is written to the cache buffer memory. Eventually the write request will be flushed from the cache memory to the iSCSI storage devices for persistent storage. The completion of that write request may then be signaled within the router and/or returned to the requesting host if necessary.

Element 500 is first operable in response to receipt of a response from a storage device to determined if the response corresponds to a forwarded read or write request. If the response corresponds to a forwarded write request, the completion status may be signaled within the caching router to permit management of the write operation. As noted, the host system may have already been signaled that its write request was completed by virtue of storing the write data in the cache memory of the caching router. When the router management processing eventually flushes the posted cache memory data to the storage devices, this signaling of completion may be applied to the management features of the caching router to recognize that the flushing write operation has completed. In alternative embodiments hereof, the host system may be informed of completion of its write request only after successful flushing of the data to the storage devices. In such embodiments, the completion signal of element 502 may be forwarded back to the host system that initiated the write request.

If element 500 determines that the response message indicates completion of a read request, element 506 is operable to update the cache buffer memory with the returned read data. Storing of read data in the cache buffer memory allows subsequent read requests for the same data to be completed more rapidly through features of the caching router. Element 508 then returns the read data to the requesting host that initiated the read operation.

FIG. 6 is a flowchart of a background process to aid in the coalescing features and aspects hereof. As noted above, as write requests are processed, smaller write requests may be held in cache memory to attempt to coalesce a plurality of smaller writes into a larger, coalesced write operation. Coalescing smaller write operations improves overall performance by reducing network traffic overhead on the storage device subnet coupled to the caching router. The smaller write requests are stored or logged in cache memory or other memory of the caching router. When a sufficient degree of coalescing of smaller writes is achieved or when a sufficient period of time has passed since the smaller write requests were received, the process of FIG. 6 may force the flushing of the saved write operations from cache memory (or other memory used to store the deferred write requests) out to the iSCSI storage devices on the storage subnet coupled to the caching router.

The method of FIG. 6 may therefore run iteratively and/or periodically to detect opportunities to flush such deferred write operations. Element 600 is operable to await the presence of any such deferred write operations. If none are presently deferred for coalescing, element 600 may loop (optionally with a brief delay) to await a next time for checking for deferred write operations. If element 600 detects that some deferred writes are presently stored in the caching controller (i.e., in cache memory or elsewhere in the caching router), element 602 determines whether the deferred operations should be flushed to persistent storage devices now. The tests to determine when to flush such deferred write operations are a matter of design choice well known to those skilled in the art. The test may involve time based decisions, decisions based on degree of coalescing involved, frequency of access to the data, or nay of numerous other factors readily apparent to those skilled in the art. Coupling of the cache memory to the routing feature s of the caching router enables such coalescing features. Particular decision regarding deferral and flushing of deferred operations are determined in accord with the needs of the particular application.

If element 602 determines that there is no present need to flush deferred operations, processing continues looping back to element 600 (optionally with a delay). If element 602 identifies some deferred write requests that may be flushed from the caching router's memory, element 604 coalesces the data to whatever extent possible and then initiates write operations to flush the coalesced data to the iSCSI persistent storage devices. Processing then continues looping back to element 600 to await additional data to be flushed to the iSCSI storage devices.

Those of ordinary skill in the art will recognize of wide variety of variations of these methods and equivalent methods to provide the desired features of improved performance by integration of caching with known features of iSCSI routing.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. A storage network appliance comprising:
a TCP/IP router for routing block level storage requests through a TCP/IP network communication medium; and
a cache memory for caching storage data blocks accessed by the block level storage requests.

2. The appliance of claim 1 further comprising:
a command and response processor coupled to the router for interpreting block level storage requests routed through the router and coupled to the cache memory for caching data identified in the interpreted block level storage requests.

3. The appliance of claim 2 wherein the block level storage requests are iSCSI protocol commands and responses.

4. The appliance of claim 3 wherein the command and response processor is a SCSI command and response processor.

5. The appliance of claim 2 wherein the command and response processor is adapted to snoop the block level storage requests routed by the router.

6. The appliance of claim 2 wherein the router is adapted to store and forward received requests.

7. The appliance of claim 6 wherein the command and response processor is adapted to process received requests while the requests are temporarily stored for forwarding.

8. The appliance of claim 2 wherein the command and response processor is adapted to retrieve information from the cache memory in response to identifying a request to access data previously stored in the cache memory.

9. The appliance of claim 8 wherein the router is adapted to conditionally forward a received command in response to operation of the command and response processor retrieving the information from the cache memory.

10. The appliance of claim 2 wherein the command and response processor is adapted to coalesce multiple block level storage write requests into a coalesced block level storage write request and wherein the router is adapted to forward the coalesced block level write request to a destination device in place of the multiple block level storage write requests.

11. A method operable in a network router comprising the steps of:
receiving a block level storage request from a network communication medium; and
processing the received block level storage request in association with a cache memory local to the router.

12. The method of claim 11 further comprising:
conditionally forwarding the received request to an intended destination device on a network communication medium in response to the processing in association with the cache memory.

13. The method of claim 11 further comprising:
coalescing multiple received block level storage requests into a coalesced block level storage request; and
forwarding the coalesced block level storage request to a destination device.

14. The method of claim 12 further comprising:
locating data requested by a received block level storage request in the cache memory; and
returning the located data to a requesting device in response to locating the requested data,
wherein the step of conditionally forwarding is operable to preclude forwarding of the received request in response to locating the requested data, and
wherein the step of conditionally forwarding is operable to forward the received request in response to failure to locate the requested data.

15. An iSCSI router comprising:
in inbound network interface for receiving iSCSI storage requests and for returning responses to received iSCSI storage requests;
an outbound network interface for forwarding received iSCSI requests to a destination device and for receiving responses from the destination device;
a cache memory; and
a control element coupled to the inbound network interface, coupled to the outbound network interface, and coupled to the cache memory and adapted to process iSCSI requests received on the inbound network interface in association with the cache memory and adapted to selectively forward processed iSCSI requests to a destination device via the outbound network interface.

16. The router of claim 15 wherein the control element further comprises:
a cache management element for storing write data supplied in a received request into the cache memory and for locating read data requested in a received request in the cache memory.

17. The router of claim 15 wherein the control element further comprises:
a request coalescing element for coalescing multiple received requests into a coalesced request,
wherein the control element is further adapted to forward the coalesced request to the destination device.

18. An improved network router compatible with TCP/IP protocols and adapted for coupling to one or more host systems and one or more iSCSI compatible storage devices, the improvement comprising:
a SCSI command and response processor within the router to process iSCSI commands and responses forwarded through the router; and
a cache memory within the router coupled to the SCSI command processor for caching data related to iSCSI commands and responses processed by the SCSI command and response processor.

19. The improved router of claim 18 wherein the SCSI command and response processor is adapted to conditionally forward received iSCSI commands to a storage device based on processing of the iSCSI command in association with the cache memory.

20. The improved router of claim 19 wherein the SCSI command and response processor is adapted to process iSCSI read requests by first attempting to locate requested data in the cache memory and wherein received iSCSI read requests are forwarded to a storage device if the requested data is not located by the processor in the cache memory.

21. The improved router of claim 19 wherein the SCSI command and response processor is adapted to process iSCSI write requests by storing the associated write data in the cache memory.

22. The improved router of claim 21 wherein the SCSI command and response processor is further adapted to coalesce data stored in the cache memory into a larger coalesced write request and is further adapted to route the coalesced write request to the storage device.
